(19) United States
(12) Patent Application Publication
(10) Pub. No.: US 2022/0333933 A1
(43) Pub. Date: Oct. 20, 2022

(54) ENHANCED VEHICLE AND TRAILER OPERATION

(71) Applicant: Ford Global Technologies, LLC, Dearborn, MI (US)

(72) Inventors: Chenhao Ma, Canton, MI (US); Alexander Lee Hunton, Dearborn, MI (US); Douglas Rogan, Ferndale, MI (US)

(73) Assignee: Ford Global Technologies, LLC, Dearborn, MI (US)

(21) Appl. No.: 17/230,303

(22) Filed: Apr. 14, 2021

(51) Int. Cl. G01C 21/34; G01C 21/00

(52) U.S. Cl. CPC G01C 21/343; G01C 21/3833

(57) ABSTRACT

Object data in a vehicle moving between first and second endpoints are collected. A path is generated between the first and second endpoints based on the object data. A heading angle of the vehicle and a heading angle of a trailer attached to the vehicle are identified when a current location of the vehicle is the first endpoint or the second endpoint. Upon determining that the heading angle of the trailer is within a threshold of the heading angle of the vehicle, one or more components of the vehicle are actuated to move the vehicle and the trailer along the path generated based on the object data.

### BACKGROUND

Vehicles can be equipped with computing devices, networks, sensors, and controllers to acquire data regarding the vehicle's environment and to operate the vehicle based on the data. Sensors can provide data to detect features of the environment, such as markings on a road or other travel surface, road signs, objects such as other vehicles or obstacles such as rocks or debris, etc. Sensor data can be provided over a vehicle network to one or more controllers or other computers on the vehicle network. Vehicle sensors can thus provide data as a vehicle travels to a destination, e.g., to determine a path or possible paths to the destination.

### BRIEF DESCRIPTION OF THE DRAWINGS

FIG. 1 is a block diagram of an example system for operating a vehicle and a trailer.

FIG. 2 is a top-down view of an example path along which the vehicle travels.

FIG. 3 is a detailed view of the path.

FIG. 4 is a top-down view of respective heading angles of the vehicle and the trailer.

FIG. 5 is a block diagram of an example process for generating the path.

FIG. 6 is a block diagram of an example process for operating the vehicle and the trailer along the path.

### DETAILED DESCRIPTION

A system includes a computer including a processor and a memory, the memory storing instructions executable by the processor to collect object data in a vehicle moving between first and second endpoints and then generate a path between the first and second endpoints based on the object data, identify a heading angle of the vehicle and a heading angle of a trailer attached to the vehicle when a current location of the vehicle is the first endpoint or the second endpoint, and, upon determining that the heading angle of the trailer is within a threshold of the heading angle of the vehicle, actuate one or more components of the vehicle to move the vehicle and the trailer along the path generated based on the object data.

The instructions can further include instructions to identify a plurality of waypoints along the generated path, each waypoint being a set of coordinates in a coordinate system that is fixed relative to the vehicle.

The instructions can further include instructions to actuate the one or more components of the vehicle to move the vehicle to each of the plurality of waypoints.

The instructions can further include instructions to identify a current location of the vehicle in the coordinate system, to identify coordinates of a next waypoint along the generated path relative to the current location of the vehicle, and to move the vehicle to the coordinates of the next waypoint.

The instructions can further include instructions to, upon actuation of the one or more components, identify a current location of the vehicle and to define the coordinate system as a two-dimensional coordinate system having a first endpoint at the current location of the vehicle.

The instructions can further include instructions to move the vehicle and the trailer in reverse from the second endpoint to the first endpoint along the generated path.

The instructions can further include instructions to move the vehicle and the trailer from the first endpoint to the second endpoint to generate the path and to then move the vehicle and the trailer in reverse from the second endpoint to the first endpoint.

The object data can include data identifying a surface of a first object, and the instructions further include instructions to generate the path to avoid the surface.

The object data can include data identifying a surface of a second object, the surface of the first object and the surface of the second object defining a corridor, and the instructions can further include instructions to generate the path through the corridor.

The instructions can further include instructions to identify coordinates of the surface in a coordinate system that is fixed relative to the vehicle and to identify a plurality of waypoints along the generated path based on the coordinates of the surface.

The instructions can further include instructions to determine the heading angle of the trailer based on data from at least one of a yaw rate sensor collecting data from the trailer or an image sensor mounted to the vehicle.

The instructions can further include instructions to identify the first endpoint and the second endpoint based on user input.

A method includes collecting object data in a vehicle moving between first and second endpoints, and then generate a path between the first and second endpoints based on the object data, identifying a heading angle of the vehicle and a heading angle of a trailer attached to the vehicle when a current location of the vehicle is the first endpoint or the second endpoint, and, upon determining that the heading angle of the trailer is within a threshold of the heading angle of the vehicle, actuating one or more components of the vehicle to move the vehicle and the trailer along the path generated based on the object data.

The method can further include identifying a plurality of waypoints along the generated path, each waypoint being a set of coordinates in a coordinate system that is fixed relative to the vehicle.

The method can further include actuating the one or more components of the vehicle to move the vehicle to each of the plurality of waypoints.

The method can further include identifying a current location of the vehicle in the coordinate system, identifying coordinates of a next waypoint along the generated path relative to the current location of the vehicle, and moving the vehicle to the coordinates of the next waypoint.

The method can further include, upon actuation of the one or more components, identifying a current location of the vehicle and defining the coordinate system as a two-dimensional coordinate system having a first endpoint at the current location of the vehicle.

The method can further include moving the vehicle and the trailer in reverse from the second endpoint to the first endpoint along the generated path.

The method can further include moving the vehicle and the trailer from the first endpoint to the second endpoint to generate the path and then moving the vehicle and the trailer in reverse from the second endpoint to the first endpoint.

The object data can include data identifying a surface of a first object, and the method can further include generating the path to avoid the surface.

The object data can include data identifying a surface of a second object, the surface of the first object and the surface of the second object defining a corridor, and the method can further include generating the path through the corridor.

The method can further include identifying coordinates of the surface in a coordinate system that is fixed relative to the vehicle and identifying a plurality of waypoints along the generated path based on the coordinates of the surface.

The method can further include determining the heading angle of the trailer based on data from at least one of a yaw rate sensor collecting data from the trailer or an image sensor mounted to the vehicle.

The method can further include identifying the first endpoint and the second endpoint based on user input.

Further disclosed is a computing device programmed to execute any of the above method steps. Yet further disclosed is a vehicle comprising the computing device. Yet further disclosed is a computer program product, comprising a computer readable medium storing instructions executable by a computer processor, to execute any of the above method steps.

Vehicles can tow trailers to transport cargo. Maneuvering the vehicle and a trailer on a narrow roadway can be difficult, particularly when avoiding objects on or near the roadway. Data on an external server, such as geo-coordinate data, may have a resolution that is too large for a vehicle to use to navigate the narrow roadway with the trailer. In particular, a vehicle and a trailer may have to move in reverse along the narrow roadway where there is insufficient room to turn the vehicle and the trailer to move back along the roadway in a forward direction.

Developing a path with detected object data from one or more vehicle sensors can provide data at a finer resolution than geo-coordinate data for a computer of the vehicle can use to move the vehicle. The object data can identify surfaces of objects near the vehicle, and the computer can generate the path between the surfaces. The computer can actuate components of the vehicle to move the vehicle and the trailer along the path. Because the path is generated with data at a finer resolution than geo-coordinate data, the computer can use the path to move the vehicle and the trailer forward and reverse to a destination.

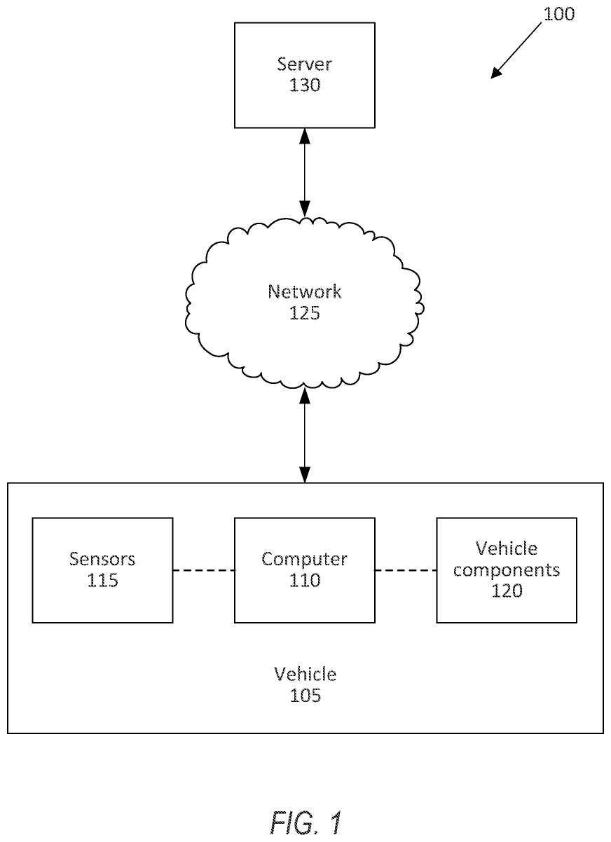

FIG. 1 illustrates an example system 100 for operating a vehicle 105 along a path. A computer 110 in the vehicle 105 is programmed to receive collected data from one or more sensors 115. For example, vehicle 105 data may include a location of the vehicle 105, data about an environment around a vehicle, data about an object outside the vehicle such as another vehicle, etc. A vehicle 105 location is provided in a two-dimensional coordinate system, e.g., geo-coordinates such as latitude and longitude coordinates obtained via a navigation system that uses the Global Positioning System (GPS), a local coordinate system defined by a fixed origin such as an initial activation location of the vehicle 105, etc. Further examples of data can include measurements of vehicle 105 systems and components, e.g., a vehicle 105 velocity, a vehicle 105 trajectory, etc.

The computer 110 is generally programmed for communications on a vehicle 105 network, e.g., including a conventional vehicle 105 communications bus such as a CAN bus, LIN bus, etc., and or other wired and/or wireless technologies, e.g., Ethernet, WIFI, etc. Via the network, bus, and/or other wired or wireless mechanisms (e.g., a wired or wireless local area network in the vehicle 105), the computer 110 may transmit messages to various devices in a vehicle 105 and/or receive messages from the various devices, e.g., controllers, actuators, sensors, etc., including sensors 115. Alternatively or additionally, in cases where the computer 110 actually comprises multiple devices, the vehicle network may be used for communications between devices represented as the computer 110 in this disclosure. For example, the computer 110 can be a generic computer with a processor and memory as described above and/or may include an electronic control unit (ECU) or controller or the like for a specific function or set of functions, and/or a dedicated electronic circuit including an ASIC that is manufactured for a particular operation, e.g., an ASIC for processing sensor data and/or communicating the sensor data. In another example, computer 110 may include an FPGA (Field-Programmable Gate Array) which is an integrated circuit manufactured to be configurable by an occupant. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g. stored in a memory electrically connected to the FPGA circuit. In some examples, a combination of processor(s), ASIC(s), and/or FPGA circuits may be included in computer 110.

In addition, the computer 110 may be programmed for communicating with the network 125, which, as described below, may include various wired and/or wireless networking technologies, e.g., cellular, Bluetooth®, Bluetooth® Low Energy (BLE), wired and/or wireless packet networks, etc.

The memory can be of any type, e.g., hard disk drives, solid state drives, servers, or any volatile or non-volatile media. The memory can store the collected data sent from the sensors 115. The memory can be a separate device from the computer 110, and the computer 110 can retrieve information stored by the memory via a network in the vehicle 105, e.g., over a CAN bus, a wireless network, etc. Alternatively or additionally, the memory can be part of the computer 110, e.g., as a memory of the computer 110.

Sensors 115 can include a variety of devices. For example, various controllers in a vehicle 105 may operate as sensors 115 to provide data via the vehicle 105 network or bus, e.g., data relating to vehicle speed, acceleration, location, subsystem and/or component status, etc. Further, other sensors 115 could include cameras, motion detectors, etc., i.e., sensors 115 to provide data for evaluating a position of a component, evaluating a slope of a roadway, etc. The sensors 115 could, without limitation, also include short range radar, long range radar, LIDAR, and/or ultrasonic transducers.

Collected data can include a variety of data collected by the sensors 115. Examples of collected data are provided above, and moreover, data are generally collected using one or more sensors 115, and may additionally include data calculated therefrom in the computer 110, and/or at the server 130. In general, collected data may include any data that may be gathered by the sensors 115 and/or computed from such data.

The vehicle 105 can include a plurality of vehicle components 120. In this context, each vehicle component 120 includes one or more hardware components adapted to perform a mechanical function or operation—such as moving the vehicle 105, slowing or stopping the vehicle 105, steering the vehicle 105, etc. Non-limiting examples of components 120 include a propulsion component (that includes, e.g., an internal combustion engine and/or an electric motor, etc.), a transmission component, a steering component (e.g., that may include one or more of a steering wheel, a steering rack, etc.), a brake component, a park assist component, an adaptive cruise control component, an adaptive steering component, a movable seat, and the like. Components 120 can include computing devices, e.g., electronic control units (ECUs) or the like and/or computing devices such as described above with respect to the computer 110, and that likewise communicate via a vehicle 105 network.

A vehicle 105 can operate in one of a fully autonomous mode, a semiautonomous mode, or a non-autonomous mode. A fully autonomous mode is defined as one in which each of vehicle 105 propulsion (typically via a powertrain including an electric motor and/or internal combustion engine), braking, and steering are controlled or monitored by the computer 110. A semi-autonomous mode is one in which at least one of vehicle 105 propulsion (typically via a powertrain including an electric motor and/or internal combustion engine), braking, and steering are controlled or monitored at least partly by the computer 110 as opposed to a human operator. In a non-autonomous mode, i.e., a manual mode, the vehicle 105 propulsion, braking, and steering are controlled by the human operator.

The system 100 can further include a network 125 connected to a server 130. The computer 110 can further be programmed to communicate with one or more remote sites such as the server 130, via the network 125, such remote site possibly including a processor and a memory. The network 125 represents one or more mechanisms by which a vehicle computer 110 may communicate with a remote server 130. Accordingly, the network 125 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth®, Bluetooth® Low Energy (BLE), IEEE 802.11, vehicle-to-vehicle (V2V) such as Dedicated Short Range Communications (DSRC), etc.), local area networks (LAN) and/or wide area networks (WAN), including the Internet, providing data communication services.

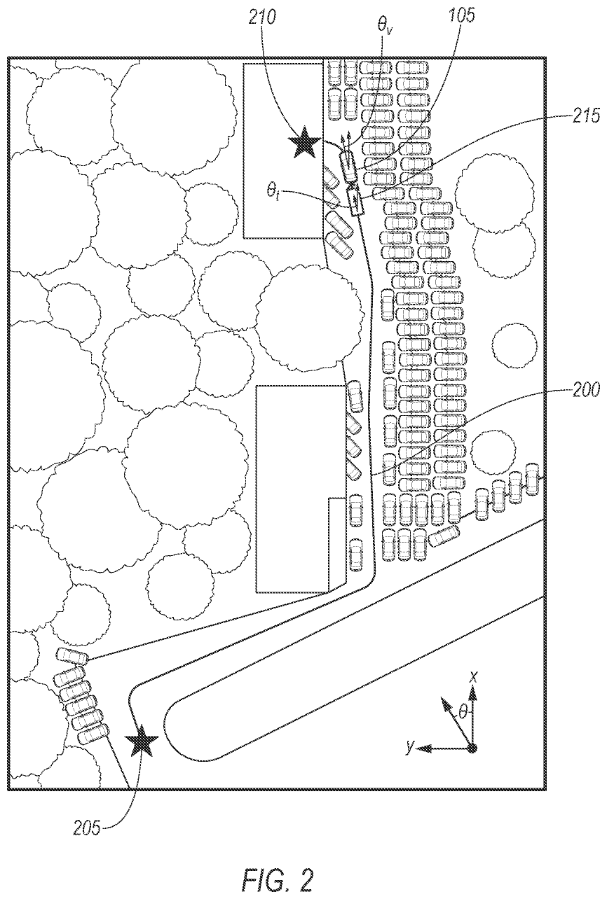

FIG. 2 is a top-down view of an example path 200 that a vehicle 105 travels. The path 200 is a set of coordinates in a coordinate system along which the vehicle 105 moves. The coordinate system can be a global coordinate system, e.g., geo-coordinates from an external server 130, or a local coordinate system. The local coordinate system can be a two-dimensional coordinate system having an origin at a location at which the vehicle 105 most recently activated. Alternatively, the two-dimensional coordinate system can have a different origin, e.g., a fixed location of a central server 130, a location specified by a user of the vehicle 105, etc. The coordinate system can define a longitudinal X axis in a vehicle-forward direction and a lateral Y axis perpendicular to the longitudinal axis. A heading angle θᵥ of the vehicle 105 is defined relative to the longitudinal X axis, with counterclockwise being a positive heading angle θᵥ.

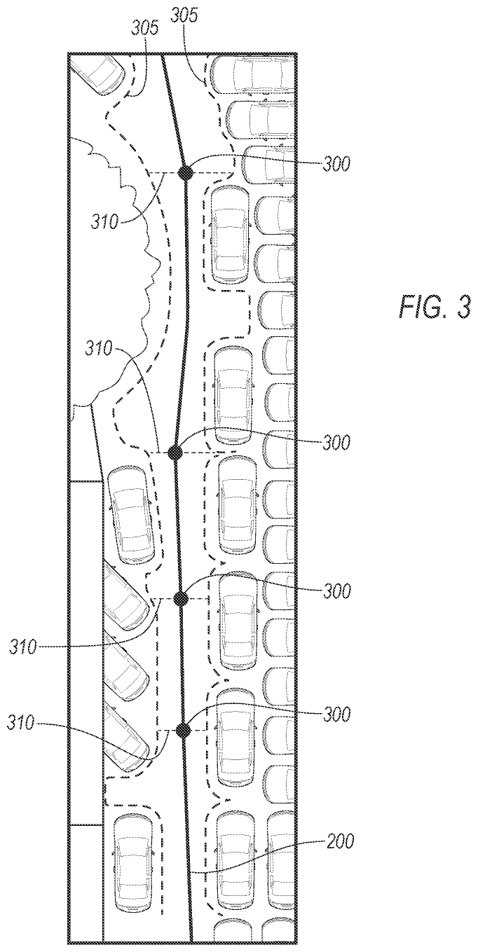

The path 200 extends from a first endpoint 205 to a second endpoint 210. The endpoints 205, 210 are locations that define the beginning and the end of the path 200. The user of the vehicle 105 can provide a first input to the computer 110 to specify a beginning or starting location for a path 200. To initially generate the path 200, the computer 110 can store the beginning location at or for which the user provides the first input as the first endpoint 205. As the vehicle 105 moves from the first endpoint 205, the computer 110 can store coordinate data in the coordinate system as the path 200. For example, the computer 110 can identify a plurality of waypoints, shown in FIG. 3 and described below, based on data of objects near the vehicle 105. The user can provide a second input to the computer 110 indicating the end of the path 200. The computer 110 stores the location at which the user provided the second input as the second endpoint 210, completing the generation of the path 200. For example, the computer 110 can use conventional path planning techniques using map data to generate a set of geo-coordinates for the vehicle 105 to traverse between the endpoints 205, 210. The computer 110 stores the path 200 and the endpoints 205, 210 in the memory; as described further below, the computer 110 can then operate the vehicle 105 based on the path 200 but moving to locations at a finer degree of resolution or granularity than would be possible if based solely on geo-coordinates specified for the path 200.

The computer 110 can move the vehicle 105 along the stored path 200 when a current location of the vehicle 105 is one of the first or second endpoints 205, 210 identified in the manner described above during generation of the path 200. The endpoints 205, 210 may be locations to which a user frequently moves the vehicle 105, and when the vehicle 105 is at one of the endpoints 205, 210, the user may intend to move to the other of the endpoints 205, 210. For example, the user may move the vehicle 105 to the second endpoint 210 and then intend to move the vehicle 105 in reverse to the first endpoint 205. To assist the user, the computer 110 can actuate one or more components 120 to move the vehicle 105 between the endpoints 205, 210 along the stored path 200. That is, the computer 110 can move the vehicle 105 along the stored path 200 with less or no input from the user, i.e., in the semiautonomous or the autonomous mode described above. The computer 110 determines that the current location of the vehicle 105 is one of the endpoints 205, 210 when coordinates of the location of the vehicle 105 in the coordinate system are within a distance threshold of one of the endpoints 205, 210. The distance threshold can be a distance specified by, e.g., a manufacturer, within which the user may begin following the path 200. For example, the distance threshold can be 1 meter.

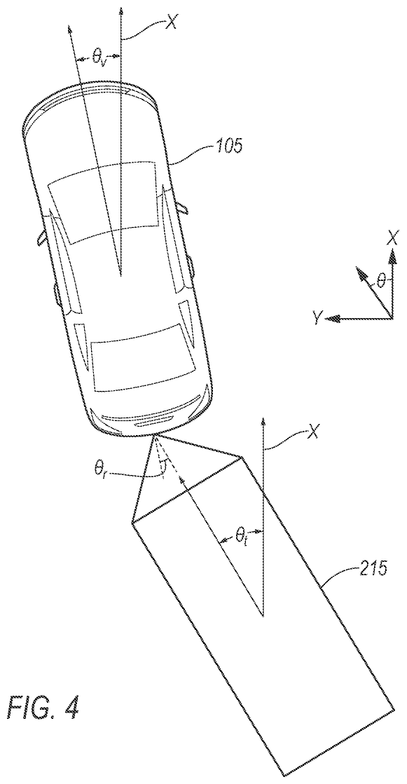

A trailer 215 can be attached to the vehicle 105. The trailer 215 can carry, e.g., cargo. The trailer 215 can be attached to a rear of the vehicle 105 with, e.g., a hitch. The vehicle 105 can transport cargo in the trailer 215 to the second endpoint 210. The vehicle 105 can move the trailer 215 from the first endpoint 205 to the second endpoint 210 along the path 200. As described below and shown in FIGS. 2 and 4, the vehicle 105 has a heading angle θᵥ and the trailer 215 has a heading angle θₜ, i.e., angles θ define relative to the longitudinal X axis.

FIG. 3 is a view of a plurality of waypoints 300 of the path 200. In this context, a “waypoint” is a set of coordinates in the coordinate system along the path 200. Each waypoint 300 is a location identified by the computer 110 to move the vehicle 105 when generating the path 200. That is, the waypoints 300 are defined by locations of the vehicle 105 in the coordinate system while generating the path 200. When the computer 110 determines to move the vehicle 105 along the path 200, the computer 110 can move the vehicle 105 between the identified waypoints 300, i.e., from a first waypoint 300 to a second waypoint 300. That is, the computer 110 can determine a location of the vehicle 105 in the coordinate system, compare the current location of the vehicle 105 to the coordinates of a next waypoint 300, and then actuate a propulsion, a steering, and/or a brake to move the vehicle 105 to the waypoint 300. The computer 110 can continue to move the vehicle 105 to successive waypoints 300 until the vehicle 105 is at one of the endpoints 205, 210, ending the path 200.

The computer 110 can collect object data of nearby objects to determine the waypoints 300 of the path 200. The “object data” are data describing surfaces of objects in an environment near the vehicle 105. Conventional geo-coordinates from an external server 130 may not identify objects in the environment, and the computer 110 can use the object data to determine locations for waypoints 300 of the path 200. That is, the object data can indicate surfaces of objects that may not have data stored in an external server 130, and the computer 110 can define an environmental model based on the object data. The computer 110 can classify each detected object a “stationary” object or a “dynamic” object based on detected speed of the object, the speed determined based on collect data from one or more sensors 115, e.g., a radar that determines a speed of the object based on reflected radio waves emitted from the radar. When the speed of the object is above a predetermined threshold, e.g., 1 meter per second, the computer 110 classifies the object as a “dynamic” object. When the speed of the object is below the threshold, the computer 110 classifies the object as a “stationary” object. The threshold can be determined based on empirical data of speeds of objects that move in a test environment, e.g., vehicle moving out of parking spaces, bicycles moving in a roadway, pedestrians moving on a sidewalk, etc. As described below, the computer 110 can determine the path 200 based on stationary objects in the environment.

Upon collecting the object data, the computer 110 can determine the waypoints 300 to generate the path 200. The computer 110 can identify the waypoints 300 as a midpoint between object boundaries 305 identified in the object data. That is, the object data can define an open space through which the vehicle 105 can move, i.e., a corridor. The corridor is bounded by the surfaces of the object data. The surfaces are determined by data collected by one or more sensors 115, e.g., a radar. That is, based on an elapsed time between emission and collection of radar waves, the computer 110 can identify distances to surfaces of objects nearest to the vehicle 105. These distances represent boundaries 305 beyond which the vehicle 105 would collide with the objects, as shown in FIG. 3. To avoid the boundaries 305 of the objects identified in the object data, the computer 110 can determine a midpoint between two opposing portions of the boundaries 305, i.e., a point substantially equally distant from the opposing surfaces along a line 310 that is a smallest distance between both boundaries 305. The midpoint thus avoids both surfaces, and the computer 110 can define one of the waypoints 300 as the coordinates of this midpoint. Then, as the vehicle 105 approaches the newly defined waypoint 300, the computer 110 can identify another open space defined by the object data, determine another midpoint between opposing portions of the boundaries 305, and define another waypoint 300 as the determined midpoint. The computer 110 can thus identify open spaces in the object data through which the vehicle 105 moves and can define waypoints 300 within the open spaces to avoid the surfaces of objects. Then, upon reaching the second endpoint 210, the computer 110 can cease determining waypoints 300.

Alternatively, the computer 110 can determine the waypoints 300 as the coordinate data of the path 200 traveled by the vehicle 105 upon receiving initial input at the first endpoint 205. Upon receiving the input from the user indicating the first endpoint 205, the computer 110 can store location data of the vehicle 105, i.e., coordinates in the coordinate system, while the vehicle 105 moves through the corridor defined by the boundaries 305. Each data point, i.e., each set of (x, y) coordinates in the coordinate system, determined by the computer 110 can be one of the waypoints 300. Upon receiving user input indicating that the vehicle 105 has reached the second endpoint 210, the computer 110 can store the collected data points as the path 200. Thus, the waypoints 300 are each collected data point in the coordinate system, and the set of waypoints 300 can be stored as the path 200.

As the vehicle 105 moves the trailer 215 along the path 200, the computer 110 can collect data about movement of the trailer 215. As will be appreciated, the trailer 215 may not follow the path 200 exactly as the vehicle 105 follows the path 200, e.g., the trailer 215 may move away from (and/or toward) a longitudinal axis of the vehicle 105 as the vehicle 105 moves. The computer 110 can compare the location data of the trailer 215 to the boundaries 305. That is, because the boundaries 305 indicate surfaces of objects on the roadway, the computer 110 can determine whether the trailer 215 may collide with the objects based on the location data of the trailer 215. The computer 110 can, using the kinematic model, predict the location of the trailer 215 based on the collected location data of the trailer 215. When the predicted location of the trailer 215 reaches or extends beyond the boundary 305, the computer 110 can adjust operation of the vehicle 105 to move the trailer 215 away from the boundary 305. For example, the computer 110 can actuate a steering component 120 of the vehicle 105 to steer the trailer 215 away from the boundary 305, e.g., by inputting the boundaries 305 as constraints to the kinematic model and outputting a specified trajectory of the vehicle 105 from the kinematic model to move the trailer 215 within the boundaries 305.

FIG. 4 is a top-down view of the vehicle 105 and the trailer 215. The computer 110 can determine a heading angle θᵥ of the vehicle 105 and a heading angle θₜ of the trailer 215. The heading angles θᵥ, θₜ are angles relative to the longitudinal X axis of the coordinate system, with the counterclockwise direction being positive. The computer 110 can determine the heading angle θᵥ of the vehicle 105 based on data from a sensor 115, e.g., a yaw rate sensor, a steering wheel angle sensor, etc. The computer 110 can determine the heading angle θₜ of the trailer 215 based on a sensor 115 such as a yaw rate sensor mounted to the trailer 215. The computer 110 can determine the heading angle θₜ by numerically integrating collected yaw rate data from the yaw rate sensor 115 with a conventional numerical integration technique, e.g., trapezoidal integration, Simpson's Rule, etc. Alternatively, the computer 110 can determine the heading angle θₜ based on a conventional kinematic model, such as a bicycle model, that maps kinematics of the trailer 215 based on motion of the vehicle 105, e.g., a speed, a trajectory, etc. Yet further alternatively, the computer 110 can determine the heading angle θₜ with a rear image sensor 115 that can detect a relative angle θᵥ between the vehicle 105 and the trailer 215. That is, as the vehicle 105 turns, the trailer 215 may turn later than the vehicle 105, and the angle defined between the vehicle 105 and the trailer 215 is a relative angle θᵣ. The heading angle of the trailer 215 thus can be the heading angle of the vehicle 105 summed with the relative angle: θₜ=θᵥ+θᵣ. The computer 105 can determine the relative angle θᵣ with, e.g., a conventional image processing program trained to determine a trailer angle of the trailer 215 such as Pro Trailer Backup Assist™ provided by Ford Motor Co.

When a current location of the vehicle 105 is one of the first endpoint 205 or the second endpoint 210, the computer 110 can determine the heading angles θᵥ, θₜ. When the heading angle θᵥ of the vehicle 105 and the heading angle θₜ of the trailer 215 are within a threshold of each other, the computer 110 can actuate one or more components 120 to move the vehicle 105 and the trailer 215 along the path 200. When the heading angle θₜ of the trailer 215 is within the threshold of the heading angle θᵥ of the vehicle 105, the computer 110 can determine that the vehicle 105 and the trailer 215 are substantially aligned. When the vehicle 105 and the trailer 215 are substantially aligned, the trailer 215 may follow the path 200 as the vehicle 105 moves along the path 200. When the heading angle θₜ of the trailer 215 is not within the threshold of the heading angle θᵥ of the vehicle 105, the computer 110 can determine that the vehicle 105 and the trailer 215 are not substantially aligned, and the computer 110 can determine not to actuate the components 120 to move the vehicle 105 along the path without operator input. That is, the computer 110 can determine to autonomously move the vehicle 105 and the trailer 215 along the path 200 only when the vehicle 105 and the trailer 215 are substantially aligned. The threshold can be a maximum difference that, according to a kinematic model such as the bicycle model described above, the difference decreases as the vehicle 105 tows the trailer 215. That is, simulation testing can be performed with the bicycle model with specified trailer angles θᵥ, θₜ for a virtual vehicle 105 and a virtual trailer 215, and the threshold can be a maximum initial difference between the specified trailer angles θᵥ, θₜ such that the difference function of the trailer angles θᵥ, θₜ approaches zero as the bicycle model predicts movement of the vehicle 105 and the trailer 215. In another example, the threshold can be a value, e.g., determined by simulations as mentioned above, at which the trailer 200 rotates such that forward movement of the vehicle 105 may not align the vehicle 105 with the trailer 200, i.e., a “jack knife” scenario. To reduce the likelihood that the vehicle 105 enters a jack knife scenario, the computer 110 can determine the threshold to be a value at which the vehicle 105 can return the trailer 200 to alignment with the vehicle 105, e.g., 90 degrees.

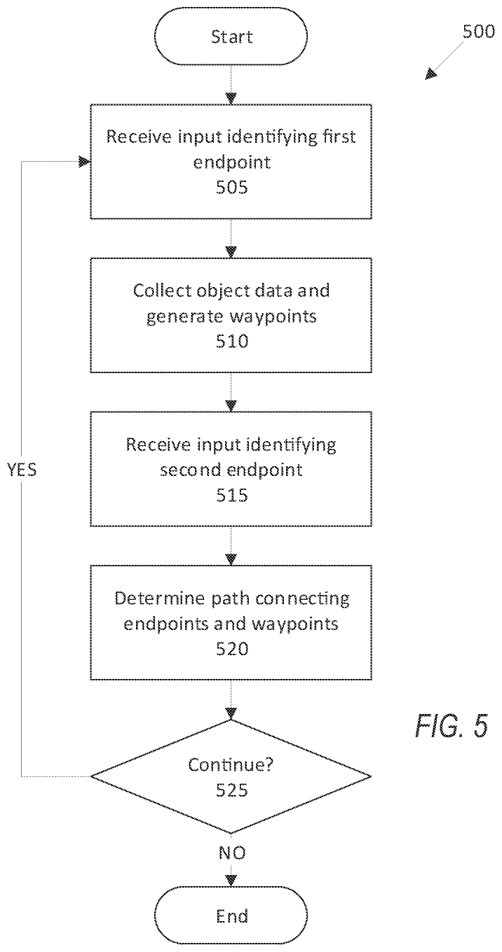

FIG. 5 is a block diagram of an example process 500 for generating a path 200 along which a vehicle 105 travels. The process 500 begins in a block 505, in which a computer 110 of the vehicle 105 receives input identifying a first endpoint 205 of the path 200. As described above, a user operating the vehicle 105 can provide input to the computer 110 indicating that a current location of the vehicle 105 is the first endpoint 205 of the path 200. The user can provide the input to a vehicle human-machine interface (HMI), e.g., via a display screen, a remote device such as a smartphone or tablet, etc.

Next, in a block 510, the computer 110 actuates one or more sensors 115 to collect object data and generate waypoints 300 of the path 200. As described above, the computer 110 can define boundaries 305 that are surfaces defined by the collected object data, the boundaries defining an open space through which the vehicle 105 can move. The computer 110 can determine the waypoints 300 as locations between the boundaries 305 to which the vehicle 105 can move.

Next, in a block 515, the computer 110 receives input from the user indicating that the vehicle 105 has arrived at a second endpoint 210. As described above, the second endpoint 210 terminates the path 200, and the computer 110 can cease determining waypoints 300 beyond the second endpoint 210. The user can provide input to, e.g., the display screen, as described above.

Next, in a block 520, the computer 110 determines the path 200 connecting the endpoints 205, 210 and the waypoints 300. As described above, the path 200 is the set of coordinates in the coordinate system of the endpoints 205, 210, the waypoints 300, and the locations traveled by the vehicle 105 between the waypoints 300. As the vehicle 105 moves between the waypoints 300, the computer 110 stores the coordinates of the locations along which the vehicle 105 traveled. The computer 110 stores the coordinates in the memory as the path 200.

Next, in a block 525, the computer 110 determines whether to continue the process 500. For example, the computer 110 can determine not to continue the process 500 when the vehicle 105 is deactivated and powered off. If the computer 110 determines to continue, the process 500 returns to the block 505. Otherwise, the process 500 ends.

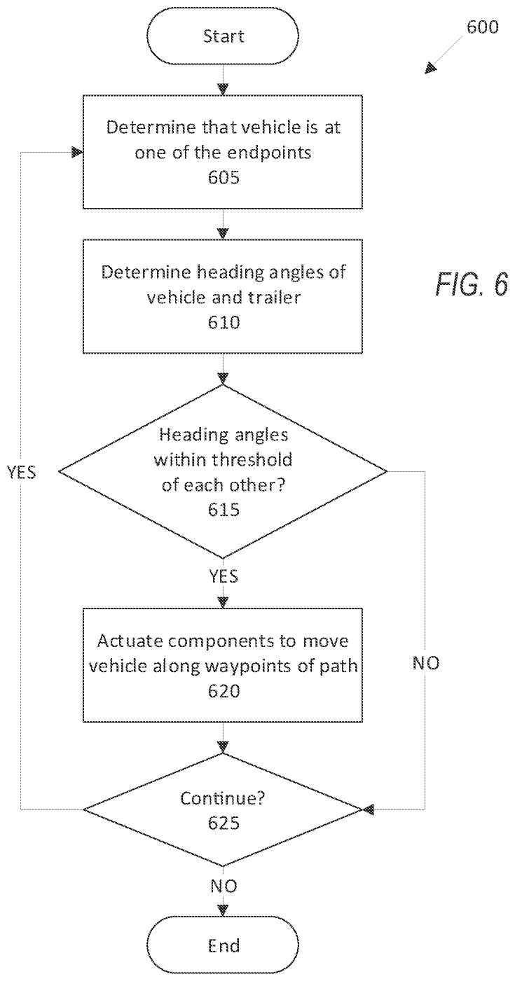

FIG. 6 is a block diagram of an example process 600 for moving a vehicle 105 and a trailer 215 along a path 200. The process 600 begins in a block 605, in which a computer 110 of the vehicle 105 determines that the vehicle 105 is at one of the endpoints 205, 210 of a stored path 200. The computer 110 compares a current location of the vehicle 105 to the stored locations of respective endpoints 205, 210 of paths 200 stored in a memory of the computer 110. When the location of the vehicle 105 is within a distance threshold of an identified one of the endpoints 205, 210, the computer 110 determines that the location of the vehicle 105 is at that identified endpoint 205, 210.

Next, in a block 610, the computer 110 determines a heading angle θᵥ, of the vehicle 105 and a heading angle θₜ of the trailer 215. As described above, the heading angles θᵥ, θₜ are angles of respective longitudinal axes of the vehicle 105 and the trailer 215 relative to the longitudinal X axis of the coordinate system. The computer 110 can determine the heading angles θᵥ, θₜ with a conventional technique, e.g., a yaw rate sensor 115, a kinematic bicycle model, etc.

Next, a block 615, the computer 110 determines whether the heading angles θᵥ, θₜ are within a threshold of each other. When the heading angles θᵥ, θₜ are within the threshold of each other, the vehicle 105 and the trailer 215 are substantially aligned and can move along the path 200 without colliding with nearby objects. If the heading angles θᵥ, θₜ are within the threshold, the process 600 continues in a block 620. Otherwise, the process 600 continues in a block 625.

In the block 620, the computer 110 actuates one or more components 120 to move the vehicle 105 along the path 200. The path 200 can be determined by identifying a plurality of waypoints 300 on object data, as shown in FIG. 5. The computer 110 can actuate a propulsion, a steering component, and/or a brake to move the vehicle 105 along waypoints 300 of the path 200. As described above, the computer 110 can actuate the vehicle 105 in forward or reverse along the path 200. For example, the computer 110 can move the vehicle 105 in reverse from the second endpoint 210 to the first endpoint 205.

In the block 625, the computer 110 determines whether to continue the process 600. For example, the computer 110 can determine to continue the process 600 when, upon completing the path 200, the user continues to move the vehicle 105 beyond the path 200. If the computer 110 determines to continue, the process 600 returns to the block 605. Otherwise, the process 600 ends.

Computing devices discussed herein, including the computer 110, include processors and memories, the memories generally each including instructions executable by one or more computing devices such as those identified above, and for carrying out blocks or steps of processes described above. Computer executable instructions may be compiled or interpreted from computer programs created using a variety of programming languages and/or technologies, including, without limitation, and either alone or in combination, Java™, C, C++, Visual Basic, Java Script, Python, Perl, HTML, etc. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in the computer 110 is generally a collection of data stored on a computer readable medium, such as a storage medium, a random access memory, etc.

A computer readable medium includes any medium that participates in providing data (e.g., instructions), which may be read by a computer. Such a medium may take many forms, including, but not limited to, non volatile media, volatile media, etc. Non volatile media include, for example, optical or magnetic disks and other persistent memory. Volatile media include dynamic random access memory (DRAM), which typically constitutes a main memory. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. For example, in the process 600, one or more of the steps could be omitted, or the steps could be executed in a different order than shown in FIG. 6. In other words, the descriptions of systems and/or processes herein are provided for the purpose of illustrating certain embodiments and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

The article “a” modifying a noun should be understood as meaning one or more unless stated otherwise, or context requires otherwise. The phrase “based on” encompasses being partly or entirely based on.

Ordinal adjectives such as “first” and “second” are used throughout this document as identifiers and are not intended to signify importance or order.

1. A system, comprising a computer including a processor and a memory, the memory storing instructions executable by the processor to:
collect object data in a vehicle moving between first and second endpoints, and then generate a path between the first and second endpoints based on the object data;
identify a heading angle of the vehicle and a heading angle of a trailer attached to the vehicle when a current location of the vehicle is the first endpoint or the second endpoint; and
upon determining that the heading angle of the trailer is within a threshold of the heading angle of the vehicle, actuate one or more components of the vehicle to move the vehicle and the trailer along the path generated based on the object data.

2. The system of claim 1, wherein the instructions further include instructions to identify a plurality of waypoints along the generated path, each waypoint being a set of coordinates in a coordinate system that is fixed relative to the vehicle.

3. The system of claim 2, wherein the instructions further include instructions to actuate the one or more components of the vehicle to move the vehicle to each of the plurality of waypoints.

4. The system of claim 3, wherein the instructions further include instructions to identify a current location of the vehicle in the coordinate system, to identify coordinates of a next waypoint along the generated path relative to the current location of the vehicle, and to move the vehicle to the coordinates of the next waypoint.

5. The system of claim 2, wherein the instructions further include instructions to, upon actuation of the one or more components, identify a current location of the vehicle and to define the coordinate system as a two-dimensional coordinate system having a first endpoint at the current location of the vehicle.

6. The system of claim 1, wherein the instructions further include instructions to move the vehicle and the trailer in reverse from the second endpoint to the first endpoint along the generated path.

7. The system of claim 6, wherein the instructions further include instructions to move the vehicle and the trailer from the first endpoint to the second endpoint to generate the path and to then move the vehicle and the trailer in reverse from the second endpoint to the first endpoint.

8. The system of claim 1, wherein the object data include data identifying a surface of a first object, and the instructions further include instructions to generate the path to avoid the surface.

9. The system of claim 8, wherein the object data include data identifying a surface of a second object, the surface of the first object and the surface of the second object defining a corridor, and the instructions further include instructions to generate the path through the corridor.

10. The system of claim 8, wherein the instructions further include instructions to identify coordinates of the surface in a coordinate system that is fixed relative to the vehicle and to identify a plurality of waypoints along the generated path based on the coordinates of the surface.

11. The system of claim 1, wherein the instructions further include instructions to determine the heading angle of the trailer based on data from at least one of a yaw rate sensor collecting data from the trailer or an image sensor mounted to the vehicle.

12. The system of claim 1, wherein the instructions further include instructions to identify the first endpoint and the second endpoint based on user input.

13. A method, comprising:
collecting object data in a vehicle moving between first and second endpoints, and then generate a path between the first and second endpoints based on the object data;
identifying a heading angle of the vehicle and a heading angle of a trailer attached to the vehicle when a current location of the vehicle is the first endpoint or the second endpoint; and
upon determining that the heading angle of the trailer is within a threshold of the heading angle of the vehicle, actuating one or more components of the vehicle to move the vehicle and the trailer along the path generated based on the object data.

14. The method of claim 13, further comprising identifying a plurality of waypoints along the generated path, each waypoint being a set of coordinates in a coordinate system that is fixed relative to the vehicle.

15. The method of claim 14, further comprising actuating the one or more components of the vehicle to move the vehicle to each of the plurality of waypoints.

16. The method of claim 15, further comprising identifying a current location of the vehicle in the coordinate system, identifying coordinates of a next waypoint along the generated path relative to the current location of the vehicle, and moving the vehicle to the coordinates of the next waypoint.

17. The method of claim 14, further comprising, upon activation of the vehicle, identifying a current location of the vehicle and defining the coordinate system as a two-dimensional coordinate system having a first endpoint at the current location of the vehicle.

18. The method of claim 13, further comprising moving the vehicle and the trailer in reverse from the second endpoint to the first endpoint along the generated path.

19. The method of claim 13, wherein the object data include data identifying a surface of a first object, and the method further comprises generating the path to avoid the surface.

20. The method of claim 13, further comprising determining the heading angle of the trailer based on data from at least one of a yaw rate sensor collecting data from the trailer or an image sensor mounted to the vehicle.
